(19) United States
(12) Patent Application Publication
(10) Pub. No.: US 2025/0297803 A1
(43) Pub. Date: Sep. 25, 2025

(54) Continuous Drying Device

(71) Applicant: Reinhard BRUNNER, Gehrden (DE)

(72) Inventors: Reinhard BRUNNER, Gehrden (DE); Christopher BRUNNER, Gehrden (DE)

(21) Appl. No.: 18/862,085

(22) PCT Filed: Apr. 27, 2023
(86) PCT No.: PCT/EP2023/061150

§ 371 Date: Oct. 31, 2024

(30) Foreign Application Priority Data
May 3, 2022 (DE) 10 2022 110 828.7
Aug. 18, 2022 (DE) 10 2022 120 887.7

(51) Int. Cl. F26B 15/12; F26B 3/04; F26B 21/02; F26B 21/04; F26B 21/08; F26B 21/12

(52) U.S. Cl. CPC F26B 15/12; F26B 3/04; F26B 21/026; F26B 21/028; F26B 21/04; F26B 21/08; F26B 21/12; F26B 2210/16

(57) ABSTRACT

The invention relates to a continuous drying device (2) for drying hygroscopic goods to be dried, comprising a drying chamber (4) for receiving the goods to be dried, comprising conveying means for conveying the goods to be dried from an inlet (6) to an outlet (8) of the drying chamber (4) during the drying process, in a conveying direction (10), and comprising air-conditioning means for setting a drying climate in the drying chamber (4) during the operation of the drying device (2), such that a plurality of climate zones (12 to 22), in which different zone climates can be set or are set or arise, are formed in succession in the conveying direction.

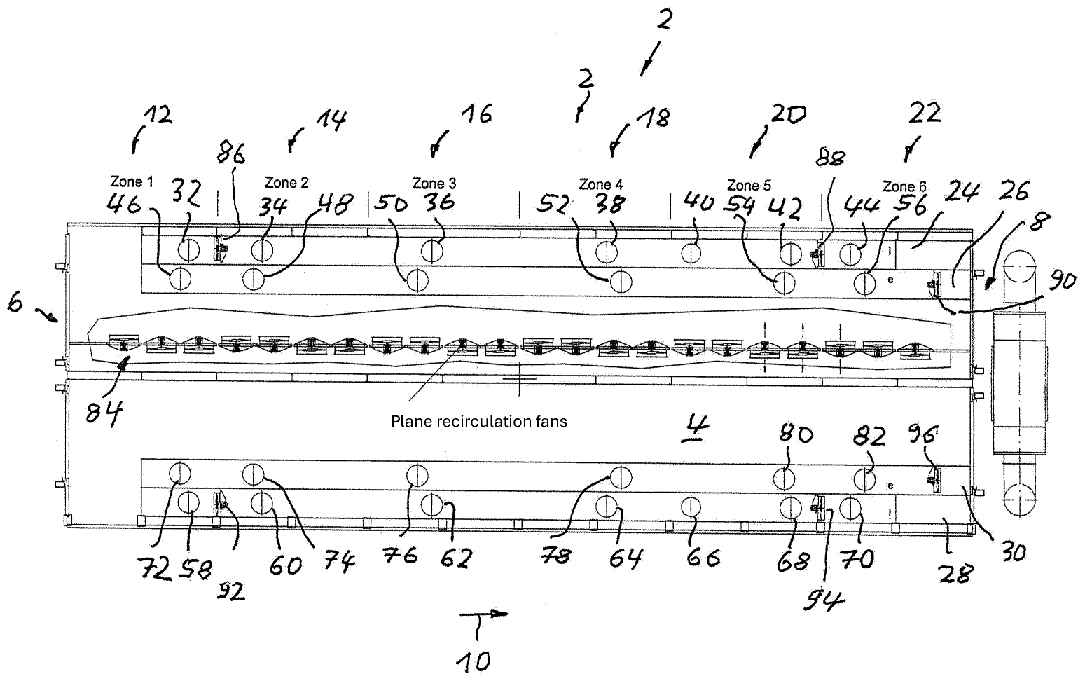

The invention relates to a continuous drying device of the type mentioned in the preamble of claim 1 for drying hygroscopic material to be dried.

Drying devices for drying hygroscopic material to be dried are generally known, for example from DE 3425642 C1, DE 3443915 C2, DE 10 2000 5030 501 A1, DE 10 2008 013 012 B4, DE 10 2010 054 493 B4, EP 0 292 717 B1, EP 1 659 218 A1 and EP 2 792 938 A2, and can serve in particular for drying sawn timber.

A continuous drying device having the features of the preamble of claim 1 is known from DE 10 2016 124 258 B4.

The object of the invention is that of specifying a continuous drying device of the type mentioned in the preamble of claim 1, which is improved compared with the known continuous drying device.

This object is achieved by the invention specified in claim 1.

Advantageous and expedient developments of the invention according to claim 1 are specified in the dependent claims.

The invention provides a continuous drying device, also referred to in the following for short as a drying device, which comprises a drying chamber for receiving the material to be dried, and conveying means for conveying the material to be dried from an inlet to an outlet of the drying space during the drying process, in a conveying direction. The drying device further comprises air-conditioning means for setting a drying climate in the drying space of the drying chamber during the operation of the drying device, such that a plurality of climate zones, in which different zone climates can be set, are set or arise, are formed in succession in the conveying direction.

According to the invention, the drying device comprises at least one flow channel, which can be brought into connection with at least some of the drying zones via closable flow openings, wherein each flow opening is assigned a blocking device for completely or partially closing the respective flow opening. Each blocking device is in control connection with a central control means which is configured and programmed such that during the drying process drying air can be introduced or is introduced from at least one climate zone into at least one other climate zone during the drying process by opening flow openings of the flow channel for setting the drying climate in at least one drying zone.

The invention makes it possible to exchange drying air between the different climate zones in the drying chamber via one or more flow channels. For example, during the drying process warm and moist drying air may be present in one climate zone due to moisture given off from the material to be dried. This drying air can then be introduced into another climate zone via the flow channel, in which zone such warm and moist drying air is required, according to the course of the drying process.

In this case, according to the invention it is possible not only for drying air to be conducted out of one climate zone into another climate zone, but rather it is also possible to mix drying air from a plurality of climate zones in a flow channel and conduct it into another climate zone. In this way it is possible for drying air, optionally with fresh air mixed in, of a desired relative humidity and air temperature, to be provided for introduction into a climate zone.

This results in increased effectiveness compared with known continuous drying devices, specifically for example and in particular with respect to the energy consumption of the device, the drying time, and an optimization of the drying process. Since, according to the invention, for example warm drying air can be introduced from one climate zone into another climate zone, the energy stored in the drying air can be used for drying the material to be dried in this climate zone. Thus, within the device for example the energy consumption is optimized, because energy, which is supplied to one climate zone from another climate zone in the form of warm drying air, does not have to be provided by a heating device. If excess thermal energy from one climate zone is not required in another climate zone, this thermal energy can be recovered via a heat exchanger.

A further advantage of the invention is that, owing to the high flexibility according to the invention when exchanging drying air between the climate zones, double embodiments of units of the drying device can be avoided. This leads to a reduced investment volume when acquiring the drying device, and reduced susceptibility to errors during operation. In this way, both acquisition and operating costs are saved.

According to the respective requirements and circumstances, according to the invention more than one flow channel can be provided. For example and in particular the drying device can comprise a supply air-side first flow channel and an exhaust air-side first flow channel.

In particular, in each case at least two flow channels can be provided both on the supply air side and on the exhaust air side. In this case, the supply air-side first flow channel can serve to establish a flow connection, on the supply air side, between the climate zones, while the supply air-side second flow channel can serve to establish a flow connection between the climate zones and a fresh air supply. In a manner corresponding thereto, the exhaust air-side first flow channel can serve to establish a flow connection, on the exhaust air side, between the climate zones, while the exhaust air-side second flow channel can serve to establish a flow connection to the external air.

According to the invention, it is also possible for more than four channels to be provided for an exchange of drying air between the climate zones.

In claim 19 a method for drying hygroscopic material to be dried is specified, in which a drying device is used which comprises
a drying chamber comprising a drying space for receiving the material to be dried,
conveying means for conveying the material to be dried from an inlet to an outlet of the drying chamber, in a conveying direction, and
air-conditioning means for setting a drying climate in the drying space of the drying chamber during the operation of the drying device, such that a plurality of climate zones is formed in succession in the conveying direction,
   wherein during operation of the drying device different zone climates can be set, are set or arise in the climate zones.

According to the invention, a drying device comprises at least one flow channel is used, which can be brought into connection with at least some of the climate zones via closable flow openings, wherein each flow opening is assigned a blocking device for completely or partially closing the respective flow opening. According to the invention, the blocking devices are actuated, during the drying process, by a control means, such that by opening flow openings of the flow channel the drying climate is set in at least one climate zone in that drying air is introduced from at least one climate zone into at least one other climate zone.

Analogously, the same advantages and properties result as in the case of the drying device according to the invention.

Preferably, for carrying out the drying method according to the invention a drying device according to the invention is used.

It is evident that the assignment of a flow channel to the supply air side or exhaust air side changes if the flow direction in the drying chamber changes by reversing recirculation fans of the drying device. Corresponding applies if the flow direction in the conveying direction of the material to be dried from one climate zone to the next changes.

The invention is explained in greater detail in the following with reference to the accompanying, highly schematic drawing and on the basis of an embodiment. It is evident to a person skilled in the art that the individual features of an embodiment develop the embodiment taken in isolation in each case, i.e. irrespective of the further features, such that it is evident to a person skilled in the art that all the features shown in the drawing and claimed in the claims form the subject matter of the invention, taken in isolation and in any technically meaningful combination with one another, irrespective of their combination in the claims and their dependency references, and irrespective of their specific description or illustration in the drawing. The subject matter and disclosure content of the present application also include combinations of features of the device claims with features of the method claims. Likewise, the subject matter and disclosure content of the present application include sub-combinations of the claims, in which at least one feature of a claim is omitted or replaced by another feature.

The single figure of the drawing is a perspective illustration of an embodiment of a continuous drying device according to the invention.

In the drawing, an embodiment of a continuous drying device 2 according to the invention, for drying hygroscopic material to be dried, is shown, which is also referred to for short in the following as a drying device or device. The fundamental structure of a continuous drying device is generally known to a person skilled in the art, and is therefore explained here only as far as this is relevant for the explanation of the invention.

In the embodiment shown, the drying device 2 serves for drying material to be dried in the form of sawn timber, and comprises a drying chamber 4 for receiving the material to be dried. In accordance with the general structure of a continuous drying device, the device 2 in the drawing comprises conveying means (not shown in further detail) for conveying the material to be dried from an inlet 6 to an outlet 8 of the drying chamber during the drying process, in a conveying direction.

In the drawing, the conveying direction is symbolized by an arrow 10. The structure and mode of operation of corresponding conveying means are generally known to a person skilled in the art, and are therefore not explained in greater detail here. In order to simplify the illustration, the conveying means are also not shown in the drawing.

The drying device 2 further comprises air-conditioning means for setting a drying climate in the drying chamber 4 during the operation of the drying device 2, such that a plurality of climate zones, in which different zone climates can be set or are set or arise, is formed in succession in the conveying direction 10. In this case, the air-conditioning means can comprise
at least one heating device for heating drying air, and/or
at least one preferably reversible recirculation fan for circulating the drying air, and/or
at least one humidification device for humidifying the material to be dried, and/or
at least one dehumidifier.

The structure and mode of operation of corresponding air-conditioning means are generally known to a person skilled in the art, and are therefore not explained in greater detail here.

In the embodiment shown, during operation of the drying device 2 six climate zones 12, 14, 16, 18, 20, 22 having different zone climates are set. The illustration of six climate zones is purely by way of example; depending on the respective requirements and circumstances it is also possible that more or fewer than six climate zones may be provided. The length of the individual climate zones 12 to 22 in the conveying direction 10 can also be selected within wide limits depending on the respective requirements and circumstances.

According to the invention, the drying device 2 comprises at least one flow channel, which can be brought into connection with at least some of the climate zones via closable flow openings.

In the embodiment shown, the drying device 2 comprises a supply air-side first flow channel 24 (internal flow channel) and a supply air-side second flow channel 26 (external flow channel).

In the embodiment shown, the drying device 2 further comprises an exhaust air-side first flow channel 28 (internal flow channel) and an exhaust air-side second flow channel 30 (external flow channel).

According to the invention, each flow channel 24 to 30 can be brought into connection with at least some of the climate zones 12 to 20 via closable flow openings, wherein each flow opening is assigned a blocking device for completely or partially closing the respective flow opening. Each blocking device is in control connection with the central control means for closing or opening the blocking device such that during the drying process drying air can be introduced or is introduced from at least one climate zone 12 to 20 into at least one other climate zone 12 to 20 during the drying process by opening flow openings of the flow channel for setting the drying climate in at least one climate zone 12 to 20.

Accordingly, during the drying process drying air can be introduced or is introduced from at least one climate zone 12 to 22 into at least one other climate zone 12 to 22 during the drying process by opening flow openings of the flow channel for setting the drying climate in at least one climate zone 12 to 22.

In the embodiment shown, each flow channel 24 to 30 to each climate zone 12 to 22 is assigned at least one flow opening.

In the embodiment shown, the supply air-side first flow channel 24 can be brought into flow connection with the climate zones 12 to 22 via flow openings 32, 34, 36, 38, 40, 42 and 44. Purely by way of example, in the embodiment shown two flow openings 40, 42 are assigned to the climate zone 20 (cf. zone 5 in the drawing).

The supply air-side second flow channel 26 can be brought into flow connection with the climate zones 12 to 22 via flow openings 46, 48, 50, 52, 54, 56. The exhaust air-side first flow channel 28 can accordingly be brought into flow connection with the climate zones 12 to 22 via flow openings 58, 60, 62, 64, 66, 68, 70.

The exhaust air-side second flow channel 30 can accordingly also be brought into flow connection with the climate zones 12 to 22 via flow openings 72, 74, 76, 78, 80, 82.

Recirculation fans for circulating the air in the drying chamber 4 are denoted by reference sign 84. In the embodiment shown, the recirculation fans 84 are reversible. In this case, the recirculation fans 84 can be actuated such that the same flow direction, i.e. either from top to bottom in the drawing or from bottom to top in the drawing, arises in the entire drying chamber 4. However, the recirculation fans 84 can also be actuated such that the flow direction changes from one climate zone to the next or in principle also within one climate zone.

Accordingly, [form] in a first flow direction the air in the drying chamber 4 (from top to bottom in the drawing). The flow openings 32 to 44 and 46 to 56 form supply air openings for introducing supply air from the supply air-side flow channels 24, 26 into the drying chamber 4, while after a reversal of the recirculation fans 84 the flow openings 58 to 70 and 72 to 82 form exhaust air openings for introducing air from the drying chamber 4 into the flow channels 28, 30.

The second supply air-side flow channel 26 and the second exhaust air-side flow channel 30 can be brought into flow connection with the external air via a flow opening that is closable by means of a blocking device, wherein the blocking device is in control connection with the central control means.

Depending on the respective requirements and circumstances, the first supply air-side flow channel 24 and the second supply air-side flow channel 26 can be interconnectable via at least one flow opening with associated blocking device. In a corresponding manner, the first exhaust air-side flow channel 28 and the second exhaust air-side flow channel 30 can also be interconnectable via at least one flow opening with associated blocking device.

In the embodiment shown, the flow channels 24 to 30 are in each case assigned at least one fan and arranged in the respective flow channel 24 to 30 for conveying drying air along the respective flow channel 24 to 30. The corresponding fans are denoted by reference signs 86, 88 (supply air-side first flow channel), 90 (supply air-side second flow channel), 92, 94 (exhaust air-side first flow channel) and 96 (exhaust air-side second flow channel).

The fans 86 to 96 are also actuated by the central control means during operation of the drying device 2.

A heating device is provided for heating the drying air in the drying device. The structure of corresponding heating device, for example in the form of one or more heater batteries, is generally known to a person skilled in the art and is therefore not explained in greater detail here. In order to simplify the illustration, the heating device is also not shown in the drawing.

Regarding the structural design, in the embodiment shown the drying chamber comprises a false ceiling above a ceiling and below a roof of the drying device, wherein an intermediate space is formed between the ceiling and the false ceiling. In this case, the flow channels 24 to 30 or at least one of the flow channels 24 to 30 can be arranged or formed in the intermediate space. For this purpose, the flow channels can be inserted into the drying device 2 as separate components, or be structurally integrated into the drying device.

For recording the drying climate, in particular air temperature, relative humidity, and air velocity, in the climate zones 12 to 22, sensor means are provided which are in data-transmitting connection with the control means. Corresponding sensor means are generally known to a person skilled in the art, and are therefore not explained in greater detail here. In order to simplify the illustration, the sensor means are also not shown in the drawing.

It is evident from the above description and drawing that the flow channels 24 to 30 are configured and extend relative to the climate zones in such a way that each of the climate zones 12 to 22 can be brought into flow connection with every other climate zone 12 to 22.

It is furthermore evident that the flow channels 24 to 30 are configured such that drying air can be guided or is guided through the flow channel in the conveying direction or counter to the conveying direction of the material to be dried.

The blocking devices assigned to the flow openings of the drying device 2 can for example in particular be configured as flaps or slides, and in the embodiment shown are moved in a motorized manner between their open position and their blocking position (closed position). The blocking devices are in control connection with the control means, such that the blocking devices are moved between their open position and their blocking position in a manner controlled by the control means.

If necessary or desired according to the respective requirements and circumstances, separating means for fluidically separating the climate zones from one another, at least in part, can be provided.

The mode of operation of the drying device 2 according to the invention is as follows:

During the drying process, a hygroscopic material to be dried in the form of stacked sawn timber is dried in the drying chamber 4. The individual stacks are conveyed through the inlet 6 into the drying chamber 4, and in the drying chamber in the direction of the arrow 10 (feed direction), pass through the climate zones 12 to 22 during the drying process, and leave the drying chamber 4 through the outlet 8 after completion of the drying process.

During the drying process, the drying climate in the individual climate zones 12 to 22 is measured by the measuring means, in particular with respect to air temperature, relative humidity and air velocity.

If it is identified during the drying process that warm and moist air, which is present for example in zone 4, is required for example in zone 2, then air is guided from zone 4 into zone 2 via the first supply air-side flow channel 24. For this purpose, the blocking device 38 (zone 4) and the blocking device 34 (zone 2) are opened, and with the aid of the fans 88, 86 an airflow is formed from the flow opening 38 of zone 4 through the flow channel 24 to the flow opening 34 of zone 2. The air thus introduced into zone 2 causes the drying process to progress in the desired manner.

Fresh air can be introduced into the climate zones 12 to 22 via the second supply air-side flow channel.

By simultaneously opening a plurality of the flow openings 32 to 44, air from two or more of the climate zones 12 to 22 can also be mixed in the flow channel 24 and introduced into another climate zone. Mixing in fresh air via a connection of the first supply air-side flow channel 24 to an external fresh air supply or by connection to the second supply air-side flow channel makes it possible for parameters of the air mixture that are relevant for the drying process, in particular relative humidity, air temperature and air velocity, can be optimally adjusted to the requirement of each climate zone 12 to 22.

Corresponding applies for the exhaust air-side flow channels 28, 30.

During the drying process, the control means continuously determines the drying air requirement of the individual climate zones from the data of the sensor means, and specifically both quantitatively and qualitatively.

Since, according to the invention, drying air is introduced as needed, in virtually any manner, from at least one of the climate zones 12 to 22 into at least one other of the climate zones 12 to 22, a particularly high degree of flexibility of the drying process results. This flexibility can be used to optimize the drying process in various ways, for example and in particular for minimizing the energy expenditure or the drying time, or with respect to the drying quality.

In addition to the flow channels 24 to 30, the drying device can comprise a feed channel for feeding warm drying air from at least one climate zone to a charging zone arranged upstream of the drying device and thus before the inlet 6 of the drying chamber 4. The purpose of the feed channel is that material to be dried stored in the charging zone can be preheated or is preheated before being introduced into the drying chamber. This prevents the material to be dried from cooling in a manner that impairs the drying process. Rather, the temperature of the material to be dried upon entry into the drying chamber 4 can be selected in a manner that positively influences the drying process, in particular in the case of low outside temperatures.

In a corresponding manner, it is also possible to guide a feed channel for feeding warm drying air from at least one climate zone to a discharging zone arranged downstream of the drying device and thus behind the inlet 6 of the drying chamber in the conveying direction, in order to protect material to be dried, provided there for collection, from frost.

1. Continuous drying device for material to be dried,
comprising a drying chamber for receiving the material to be dried,
conveying means for conveying the material to be dried from an inlet to an outlet of the drying chamber during the drying process, in a conveying direction, and
air-conditioning means for setting a drying climate in the drying chamber during the operation of the drying device, such that a plurality of climate zones, in which different zone climates can be set or are set or arise, are formed in succession in the conveying direction,
wherein
the drying device includes at least one flow channel which can be brought into connection with at least some of the climate zones via closable flowopenings,
wherein each flow opening is assigned a blocking device for fully or partially closing the respective flow opening, and
wherein each blocking device is in control connection with a central control means which is configured and programmed such that during the drying process, for setting the drying climate in at least one climate zone, drying air can be introduced or is introduced from at least one climate zone into at least one other climate zone by opening flow openings of the flow channel or the flow channels.

2. Drying device according to claim 1, wherein the drying device includes a supply air-side first flow channel and an exhaust air-side first flow channel.

3. Drying device according to claim 2, wherein the drying device includes a supply air-side second flow channel and an exhaust air-side second flow channel.

4. Drying device according to claim 2, wherein each flow channel can be brought into connection with at least some of the climate zones via closable flow openings, wherein each flow opening is assigned a blocking device for completely or partially closing the respective flow opening, wherein each blocking device is in control connection with the central control means for closing or opening the respective blocking device in such a way that during the drying process drying air from at least one climate zone can be introduced or is introduced into at least one other climate zone by opening flow openings of the respective flow channel for setting the drying climate in at least one climate zone.

5. Drying device according to claim 1, wherein at least one flow channel, preferably each flow channel is assigned a flow opening to each climate zone.

6. Drying device according to claim 2, wherein the second supply air-side flow channel and/or the second exhaust air-side flow channel can be brought into flow connection with a fresh air supply via a flow opening that is closable by means of a blocking device, wherein the blocking device is in control connection with the central control means.

7. Drying device according to claim 1, wherein the drying device includes a feed channel for feeding warm drying air from at least one climate zone to a charging zone upstream of the drying device and/or a discharging zone downstream of the drying device, such that material to be dried stored in the charging zone can be preheated or is preheated before being introduced into the drying chamber, and/or material to be dried that is stored in the discharging zone after removal from the drying chamber can be afterheated or is afterheated.

8. Drying device according to claim 1, wherein at least one flow channel is assigned at least one fan and is preferably arranged in the respective flow channel for conveying drying air along the respective flow channel.

9. Drying device according to claim 1, wherein the air-conditioning means comprise
at least one heating device for heating drying air, and/or
at least one preferably reversible recirculation fan for circulating the drying air, and/or
at least one humidification device for humidifying the material to be dried, and/or
at least one dehumidifier.

10. Drying device according to claim 9, wherein a common heating device is provided for heating the drying air in the drying device.

11. Drying device according to claim 1, wherein the drying chamber comprises a false ceiling above a ceiling and below a roof of the drying device, and an intermediate space is formed between the ceiling and the false ceiling.

12. Drying device according to claim 11, wherein at least one flow channel is arranged or formed in the intermediate space.

13. Drying device according to claim 1, wherein sensor means for recording the drying climate, in particular air temperature, relative humidity, and air velocity, is provided in at least one climate zone and/or is provided in at least one flow channel.

14. Drying device according to claim 1, wherein the first supply air-side flow channel and the second supply air-side flow channel can be interconnected via at least one flow opening with associated blocking device, and/or in that the first exhaust air-side flow channel and the second exhaust air-side flow channel can be interconnected via at least one flow opening with associated blocking device.

15. Drying device according to claim 1, wherein the or each flow channel is configured and extends relative to the climate zones in such a way that each of the climate zones can be brought into flow connection with every other climate zone.

16. Drying device according to claim 1, wherein the or each flow channel is configured such that drying air can be guided or is guided through the flow channel in the conveying direction or counter to the conveying direction of the material to be dried.

17. Drying device according to claim 1, wherein at least one blocking device is configured as a flap or slide, wherein at least one blocking device is movable in a motorized manner between its open position and its blocking position (closed position).

18. Drying device according to claim 1, wherein separating means for at least partial fluidic separation of the climate zones from one another is provided.

19. Method for drying hygroscopic material to be dried using a drying device comprising
a drying chamber including a drying space for receiving the material to be dried,
conveying means for conveying the material to be dried from an inlet to an outlet of the drying chamber, in a conveying direction, and
air-conditioning means for setting a drying climate in the drying space of the drying chamber during the operation of the drying device, such that a plurality of climate zones are formed in succession in the conveying direction,
wherein during operation of the drying device different zone climates can be set, are set or arise in the climate zones,
wherein
a drying device including at least one flow channel is used, which can be or is brought into connection with at least some of the climate zones via closable flow openings, wherein each flow opening is assigned a blocking device for completely or partially closing the respective flow opening, and
the blocking devices are actuated, during the drying process, such that by opening flow openings of the flow channel the drying climate is set in at least one climate zone in that drying air is introduced from at least one climate zone into at least one other climate zone.

20. Method for drying hygroscopic material to be dried using a drying device comprising:
a continuous drying device for material to be dried,
a drying chamber for receiving the material to be dried,
conveying means for conveying the material to be dried from an inlet to an outlet of the drying chamber during the drying process, in a conveying direction, and
air-conditioning means for setting a drying climate in the drying chamber during the operation of the drying device, such that a plurality of climate zones, in which different zone climates can be set or are set or arise, are formed in succession in the conveying direction.
wherein
the drying device includes at least one flow channel which can be brought into connection with at least some of the climate zones via closable flow,
wherein each flow opening is assigned a blocking device for fully or partially closing the respective flow opening, and
wherein each blocking device is in control connection with a central control means which is configured and programmed such that during the drying process, for setting the drying climate in at least one climate zone, drying air can be introduced or is introduced from at least one climate zone into at least one other climate zone by opening flow openings of the flow channel or the flow channels.
